(19) United States
(12) Patent Application Publication
(10) Pub. No.: US 2012/0287784 A1
(43) Pub. Date: Nov. 15, 2012

(54) SYSTEM AND METHOD FOR INTEGRATED QUALITY OF SERVICE IN A WIRELESS NETWORK ENVIRONMENT

(75) Inventors: Kevin D. Shatzkamer, Hingham, MA (US); Rajesh S. Pazhyannur, Milpitas, CA (US); Mark Millet, Mountain View, CA (US); Mark Grayson, Maidenhead (GB); David E. Dukinfield, Round Hill, VA (US); Eric Hamel, Paris (FR)

(73) Assignee: Cisco Technology, Inc.

(21) Appl. No.: 13/104,788

(22) Filed: May 10, 2011

(51) Int. Cl. H04W 28/10

(52) U.S. Cl. 370/230.1

(57) ABSTRACT

A method is provided in one example embodiment and includes receiving a request for a service flow over a wireless link, where the request specifies resource requirements; dynamically reserving bandwidth for the resource requirements in a backhaul link; and mapping a packet received over the wireless link to the backhaul link based on an identification element associated with the packet and the service flow.

### TECHNICAL FIELD

This disclosure relates in general to the field of communications, and more particularly, to a system and a method for integrated quality of service in a wireless network environment.

### BACKGROUND

Networking architectures have grown increasingly complex in communications environments: particularly mobile wireless environments. Cable operators are also steadily increasing their wireless service offerings, including 3G, WiFi, WiMAX, picocells, and femtocells, which can be linked to backhaul networks using the Data over Cable Service Interface Specification (DOCSIS). In such deployments, the radio technology is designed to provide quality of service (QoS) for services like voice, video, and specific per-subscriber service tiers. However, current delivery mechanisms are restricted to the air interface with no consistent and reliable connection to QoS over the DOCSIS link. As future applications drive increased bandwidth, current architectures may not be able to ensure that the guaranteed bitrate required for an application or service can be met. Hence, significant challenges remain for managing network resources, particularly in the context of wireless networks.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a communication system for integrated quality of service in a wireless network environment according to this disclosure;

FIG. 2A is a simplified block diagram of a backhaul in one example embodiment of the communication system;

FIG. 2B is a simplified block diagram illustrating additional details that may be associated with one potential embodiment of the communication system;

FIG. 3 is a simplified flow diagram illustrating service flow creation in a clear tunnel use case for an example embodiment of the communication system;

FIG. 4 is a simplified flow diagram illustrating service flow creation and detection in an opaque tunnel use case for an example embodiment of the communication system;

FIG. 5A is a simplified block diagram of a backhaul in an alternative embodiment of the communication system;

FIG. 5B is a simplified block diagram illustrating additional details that may be associated with an alternative embodiment of the communication system;

FIG. 6 is a simplified flow diagram illustrating service flow creation in a clear tunnel use case for another example embodiment of the communication system; and

FIG. 7 is a simplified flow diagram illustrating service flow creation and detection in an opaque tunnel use case for another example embodiment of the communication system.

### DETAILED DESCRIPTION OF EXAMPLE EMBODIMENTS

### Overview

A method is provided in one example embodiment and includes receiving a request for a service flow over a wireless link, where the request specifies resource requirements; dynamically reserving bandwidth for the resource requirements in a backhaul link; and mapping a packet received over the wireless link to the backhaul link based on an identification element associated with the packet and the service flow.

In more specific implementations, the request includes a quality of service parameter corresponding to the resource requirements. Additionally, the backhaul link can be a Data over Cable Service Interface Specification (DOCSIS) link between a cable modem and a cable modem termination system. In other embodiments, dynamically reserving bandwidth comprises creating a dedicated DOCSIS link over a hybrid fiber-coaxial backhaul for the service flow. In addition, the backhaul link can be associated with a quality of service class and dynamically reserving bandwidth comprises mapping the resource requirements to the quality of service class.

Furthermore, the backhaul link can be associated with a quality of service class having a predetermined bandwidth, where dynamically reserving bandwidth comprises modifying the predetermined bandwidth to accommodate the resource requirements. The mapping can include shallow inspection on the packet to extract the identification element and to apply a filter to match the wireless link to the backhaul link based on the identification element. In addition, the method can include mapping the quality of service parameter to a differentiated service code point and mapping the differentiated service code point to a DOCSIS service flow type.

### Example Embodiments

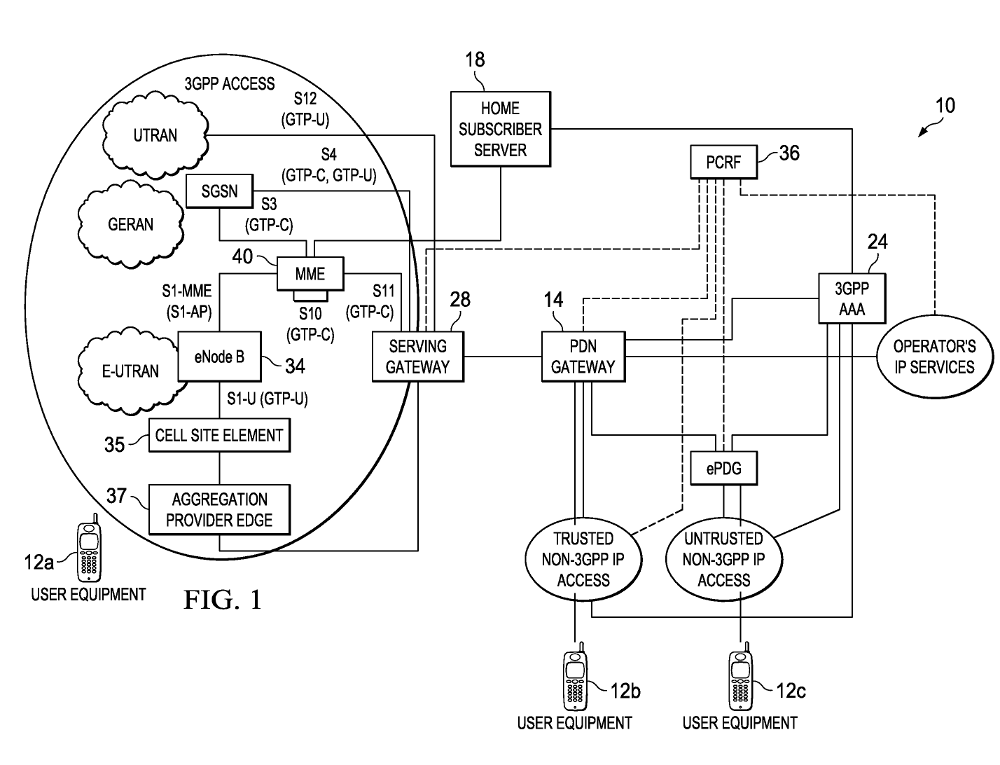

Turning to FIG. 1, FIG. 1 is a simplified block diagram of an example embodiment of a communication system 10 for providing integrated quality of service (QoS) in a network environment. This particular configuration may be tied to the 3rd Generation Partnership Project (3GPP) Evolved Packet System (EPS) architecture, also sometimes referred to as the Long-Term Evolution (LTE) EPS architecture, but alternatively this depicted architecture may be equally applicable to other environments. The example architecture of FIG. 1 includes multiple end users operating user equipment (UE) 12a-c and a packet data network (PDN) gateway (PGW) 14, which has a logical connection to a serving gateway (SGW) 28. Also provided is a home subscriber server (HSS) 18 and an Authentication, Authorization, and Accounting (AAA) element 24. SGW 28 has a logical connection to an eNodeB 34, a cell site element 35, an aggregation provider element (Agg-PE) 37, and a Mobility Management Entity (MME) 40. Both SGW 28 and PGW 14 can interface with a Policy and Charging Rules Function (PCRF) 36.

Each of the elements of FIG. 1 may couple to one another through simple interfaces (as illustrated) or through any other suitable connection (wired or wireless), which provides a viable pathway for network communications. Additionally, any one or more of these elements may be combined or removed from the architecture based on particular configuration needs. Communication system 10 may include a configuration capable of transmission control protocol/Internet protocol (TCP/IP) communications for the transmission or reception of packets in a network. Communication system 10 may also operate in conjunction with a user datagram protocol/IP (UDP/IP) or any other suitable protocol where appropriate and based on particular needs.

Also provided in the architecture of FIG. 1 is a series of interfaces, which can offer mobility, policy control, AAA functions, and charging activities for various network elements. For example, interfaces can be used to exchange point of attachment, location, and access data for one or more end users. Resource, accounting, location, access network information, network address translation (NAT) control, etc. can be exchanged using a remote authentication dial in user service (RADIUS) protocol, or any other suitable protocol where appropriate. Other protocols to be used in such communications can include Diameter, service gateway interface (SGI), terminal access controller access-control system (TACACS), TACACS+, etc.

There are two access cases represented in FIG. 1, which depicts these as trusted and untrusted non-3GPP IP access. For the trusted scenario, a viable relationship exists between the service provider and the core network. For the untrusted scenario, a suitable security mechanism can be provided to ensure the integrity of the data communications (e.g., encryption and decryption operations can occur in this scenario and, further, involve an evolved packet data gateway (ePDG), which has a logical connection to PCRF 36 as shown in FIG. 1).

In more general terms, 3GPP defines EPS as specified in TS 23.401, TS.23.402, TS 23.203, etc. The EPS generally consists of IP access networks and an Evolved Packet Core (EPC). Access networks may be 3GPP access networks, such a GERAN, UTRAN, and E-UTRAN, or they may be non-3GPP IP access networks such as digital subscriber line (DSL), Cable, WiMAX, code division multiple access (CDMA) 2000, WiFi, or the Internet. Non-3GPP IP access networks can be divided into trusted and untrusted segments. Trusted IP access networks support mobility, policy, and AAA interfaces to the EPC, whereas untrusted networks do not. Instead, access from untrusted networks is done via the ePDG, which provides for IPsec security associations to the user equipment over the untrusted IP access network. The ePDG (in turn) supports mobility, policy, and AAA interfaces to the EPC, similar to the trusted IP access networks.

Before detailing the operations and the infrastructure of FIG. 1, certain contextual information is provided to offer an overview of some problems that may be encountered while providing QoS in a wireless network environment. Such information is offered earnestly and for teaching purposes only and, therefore, should not be construed in any way to limit the broad applications of the present disclosure.

Data over Cable Service Interface Specification (DOCSIS) is an international telecommunications standard, which permits the addition of high-speed data transfer to an existing cable TV (CATV) system. DOCSIS may be deployed by operators to provide Internet access over, for example, hybrid fiber-coaxial (HFC) infrastructure. Typically, a DOCSIS architecture includes two primary components: a cable modem (CM) located at the customer premises, and a cable modem termination system (CMTS) located at the headend. Cable systems supporting on-demand programming can use a hybrid fiber-coaxial system. Fiber optic lines can bring digital signals to nodes in the system, where they can be converted into RF channels and modem signals on coaxial trunk lines. A typical CMTS is a device that hosts downstream and upstream ports.

Outdoor wireless networks have gained significant notoriety. Certain implementations provision a wireless base station and a backhaul that uses a cable modem, which offers bi-directional data communication over an HFC infrastructure. For example, some networks may include WiFi, WiMAX, and LTE strand-mounted systems, which rely on a DOCSIS link over an HFC infrastructure. Other examples may include an integrated DOCSIS modem with multiple SSID WiFi access points, and integrated DOCSIS modem and femtocell devices.

Logistically, service providers have chosen to mount radios on certain network equipment, where the attached radios include a cable modem that provides IP connectivity. Base stations are configured to carry traffic for which certain data rate levels are ensured. Additionally, there are certain classes of service within the traffic such that network characteristics (e.g., latency and jitter) can be accommodated by the architecture. The base station typically administers higher rates of service over the air (e.g., over a cellular interface); however, the base station is not able to control traffic along the backhaul. This is because the backhaul is controlled by the cable modem and the CMTS.

Operationally, in a typical wireless deployment, the radio technology (WiFi, WiMAX, 3G, etc.) would be designed to provide QoS for services like voice, video, or specific per-subscriber service tiers. However, these implementations do not address QoS over the backhaul. Rather, QoS requirements (and delivery mechanisms) are generally restricted to the air interface with no connections or tie-ins to QoS requirements (and delivery mechanisms) over the DOCSIS link. Thus, for example, over-the-air interface voice packets may be delivered with guaranteed bounds on delay, jitter, and packet loss. However, once these packets are sent to the backhaul, they generally would compete with other (best effort) traffic, where the over-the-air guaranteed bounds are not useful if a DOCSIS link is allowed to introduce wide variations on such metrics. Upstream QoS across a DOCSIS link can become overwhelmed with multiple active devices using less than the maximum pre-allocated backhaul bandwidth, but (taken together) they can cause congestion. Given these obstacles, providing guaranteed service over such systems remains challenging.

Moreover, in cases where a service provider seeks to provide an end-to-end service, where both the wireless link and the cable link should be provisioned appropriately, there is no mechanism to accomplish this objective. Stated in different terminology, LTE, WiMAX, 3GPP define a signaling mechanism for quality of service at the air interface (i.e., between the base station and the mobile device), but these architectures fail to provide for such a mechanism over the DOCSIS link.

In accordance with one embodiment, communication system 10 can overcome some of the aforementioned shortcomings (and others) by managing service flow creation for delivering integrated QoS across both a wireless link and a DOCSIS link to achieve end-to-end QoS. In more particular embodiments of communication system 10, an eNodeB may signal a cable modem or a CMTS to dynamically reserve bandwidth for QoS requirements and, subsequently, map wireless link signaling to DOCSIS signaling, thus providing fine-grained QoS guarantees and more efficient network use through dynamic QoS (DQoS) over the DOCSIS link.

In certain embodiments, communication system 10 may use clear tunnels between an eNodeB and an MME, in which S1-AP tunnel packets may be sent without any end-to-end (E2E) encryption and, further, there may be no IPsec or Layer 2 (L2) virtual private network (VPN). To create a service flow with E2E QoS in such an embodiment, communication system 10 may map LTE QoS parameters to DOCSIS resource requirements and, further, have an interface between the eNodeB and a cable modem to signal for a new DOCSIS service flow having the resources to accommodate the QoS requirements, effectively establishing one pipe per service flow. To detect an LTE service flow and map it to the appropriate DOCSIS service flow, the cable modem and a CMTS may do shallow inspection on tunneled packets to extract flow identification elements (e.g., the source address and port, destination address and port, protocol type, etc.). Filters can then be applied to match the LTE service flow to the appropriate DOCSIS service flow. Note that the term ‘identification element’, as used herein in this Specification, can include (but is not limited to) the source address and port, destination address and port, protocol type, security information, formatting, packet size, or any other suitable parameter that may be relevant to identifying data segments.

In other embodiments, communication system 10 may use opaque tunnels between an eNodeB and an MME, in which S1-AP tunnel packets may be encrypted (L2/L3 VPN) and an L2 may be used between an eNodeB and an MME. To create a service flow with E2E QoS in such an embodiment, communication system 10 may have an interface between the eNodeB and a cable modem to signal DOCSIS flow creation, and map LTE service flows to an aggregate DOCSIS flow bundle: effectively establishing one pipe per QoS class. More particularly, LTE service flows may be mapped into a single DOCSIS real-time polling service (rtPS) flow. Parameters of DOCSIS service flows (such as averages and peak rates) can be modified as LTE service flows are added and deleted. To detect an LTE service flow and map it to the appropriate DOCSIS service flow, the eNodeB and MME may mark service types with corresponding differentiated service code points (DSCP) markings, and the cable modem and CMTS may be provisioned to map DSCP into DOCSIS service flows.

Returning to FIG. 1, UE 12a-c can be associated with clients or customers wishing to initiate a flow in communication system 10 via some network. The terms ‘user equipment’, ‘mobile node’, ‘end user’, ‘and ‘subscriber’ are inclusive of devices used to initiate a communication, such as a computer, a personal digital assistant (PDA), a laptop or electronic notebook, a cellular telephone, an i-Phone, i-Pad, a Google Droid phone, any smartphone, an IP phone, or any other device, component, element, or object capable of initiating voice, audio, video, media, or data exchanges within communication system 10. UE 12a-c may also be inclusive of a suitable interface to a user such as a microphone, a display, a keyboard, or other terminal equipment.

UE 12a-c may also be any device that seeks to initiate a communication on behalf of another entity or element such as a program, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another. In certain embodiments, UE 12a-c have a bundled subscription for network access and application services (e.g., voice), etc. Once the access session is established, the user can register for application services as well, without additional authentication requirements. There can be two different user data repositories (AAA databases): one for the access user profile and one for the application user profile. IP addresses can be assigned using dynamic host configuration protocol (DHCP), Stateless Address Auto-configuration, default bearer activation, etc., or any suitable variation thereof.

PCRF 36 is a network element responsible for coordinating charging and/or policy decisions for UE 12a-c. PCRF 36 can be configured to use subscription information as a basis for the policy and charging control decisions. The subscription information may apply for both session-based and non-session based services. PCRF 36 can maintain session linking to the sessions via policy interactions with PGW 14 (and possibly SGW 28) and application functions (e.g., provided as part of the operator's IP services). An application function (AF) can be provided within PCRF 36 (or simply interact with PCRF 36) in order to offer applications that require dynamic policy and/or charging control. The AF can communicate with PCRF 36 to transfer dynamic session information. Additionally, any type of policy and/or charging control element (e.g., PCC infrastructure) can be provided within (or suitably interact with) PCRF 36.

HSS 18 offers a subscriber database in 3GPP (e.g., GSM, LTE, etc.) environments. In one sense, HSS 18 can provide functions similar to those offered by an AAA server in a CDMA environment. When a user moves to 3GPP access, HSS 18 can be aware of this location and this anchor point (i.e., PGW 14). Additionally, HSS 18 can communicate with AAA element 24 such that when a UE moves to a CDMA environment, it still has an effective anchor for communications (i.e., PGW 14). HSS 18 and AAA element 24 can coordinate this state information for the UE (and synchronize this information) to achieve mobility. No matter how a UE moves, the access network element can be interacting with either HSS 18 or AAA element 24 in order to identify which PGW should receive the appropriate signaling. The route to a UE can be consistently maintained, where routing topology ensures that data is sent to the correct IP address. Thus, synchronization activity on the backend of the architecture allows mobility to be achieved for the user when operating in different environments. Additionally, in certain examples, PGW 14 performs home agent functions, and the trusted non-3GPP IP access network can provide packet data serving node (PDSN) functions in order to achieve these objectives.

AAA element 24 is a network element responsible for accounting, authorization, and authentication functions for UEs 12a-c. For the AAA considerations, AAA element 24 may provide the mobile node IP address and the accounting session identification (Acct-Session-ID) and other mobile node states in appropriate messaging (e.g., via an access-Request/access-Accept message). An accounting message can be sent for the following events: accounting-start when the IP session is initially created for the mobile node on the gateway; accounting-interim-update when a handover occurred between gateways; and an accounting-stop when the IP session is removed from the gateway serving the element. For roaming scenarios, the home routed case is fully supported by the architecture.

The EPC generally comprises an MME, an SGW, a PGW, and a PCRF. The MME is the primary control element for the EPC. Among other things, the MME provides tracking area list management, idle mode UE tracking, bearer activation and deactivation, SGW and PGW selection for UEs, and authentication services. The SGW is a data plane element that can manage user mobility and interfaces with RANs. The SGW also can maintain the data paths between eNodeBs and the PGW, and serves as a mobility anchor when UEs move across areas served by different eNodeBs. The PGW provides connectivity for UEs to external packet data networks. The PCRF detects service flows and enforces charging policies.

RANs in an LTE architecture can consist of eNodeBs (also known as eNBs). An eNodeB is generally connected directly to an EPC, as well as to adjacent eNodeBs. Connections with adjacent eNodeBs allow many calls to be routed more directly, often with minimal or no interaction with an EPC. An eNodeB is also responsible for selecting an MME for UEs, managing radio resources, and making handover decisions for UEs.

In operation, UE 12a can attach to the network for purposes of establishing a communication session. UE 12a can communicate with eNodeB 34, which can further interact with MME 40 to complete some form of authentication for a particular user. MME 40 can interact with SGW 28, which interacts with PGW 14 such that a session is being setup between these components. Tunnels could be established at this juncture, and a suitable IP address could also be issued for this particular user. This process generally involves a default EPS bearer being created for UE 12a. As the session is established, PGW 14 can interact with PCRF 36 to identify policies associated with this particular user, such as a certain QoS setting, bandwidth parameter, latency setting, priority, billing, etc.

An EPS bearer/E-UTRAN Radio Access Bearer (E-RAB) is the level of granularity for bearer level QoS control in the EPC/E-UTRAN. Thus, Service Data Flows (SDFs) mapped to the same EPS bearer can receive the same bearer level packet forwarding treatment (e.g. scheduling policy, queue management policy, rate shaping policy, RLC configuration, etc.). One EPS bearer/E-RAB can be established when the UE connects to a PDN. This bearer, which is generally referred to as the “default bearer,” may remain established throughout the lifetime of the PDN connection to provide the UE with always-on IP connectivity to that PDN. Any additional EPS bearer/E-RAB that may be established to the same PDN is generally referred to as a “dedicated bearer.” The initial bearer level QoS parameter values of the default bearer are assigned by the network, based on subscription data. The decision to establish or modify a dedicated bearer can be taken by the EPC, and the bearer level QoS parameter values may be assigned by the EPC.

Dedicated network resources related to a Guaranteed Bit Rate (GBR) value that is associated with the EPS bearer/E-RAB may be permanently allocated (e.g., by an admission control function in the eNodeB) at bearer establishment/modification. An EPS bearer/E-RAB having a GBR is generally referred to as a “GBR bearer.” Otherwise, an EPS bearer/E-RAB is referred to as a “Non-GBR bearer.” A dedicated bearer can be either a GBR or a Non-GBR bearer, but a default bearer is a Non-GBR bearer.

The bearer level QoS parameters may include a QoS Class Identifier (QCI), Allocation and Retention Priority (ARP), GBR, and Aggregate Maximum Bit Rate (AMBR). Each EPS bearer/E-RAB (GBR and Non-GBR) is generally associated with QCI and ARP parameters, while GBR bearers may additionally be associated with GBR. A QCI is generally a scalar used as a reference to access node-specific parameters that control bearer level packet forwarding treatment (e.g., scheduling weights, admission thresholds, queue management thresholds, link layer protocol configuration, etc.), and that have been pre-configured by the operator owning the eNodeB. In many embodiments, there are nine unique classes of service that depend on packet delay budget. Voice and video are generally offered using a QCI of 1 or 2, for example. ARP may be used to decide whether a bearer establishment or modification request can be accepted or should be rejected because of resource limitations. ARP can also be used by the eNodeB to decide which bearer(s) to drop during exceptional resource limitations (e.g., at handover).

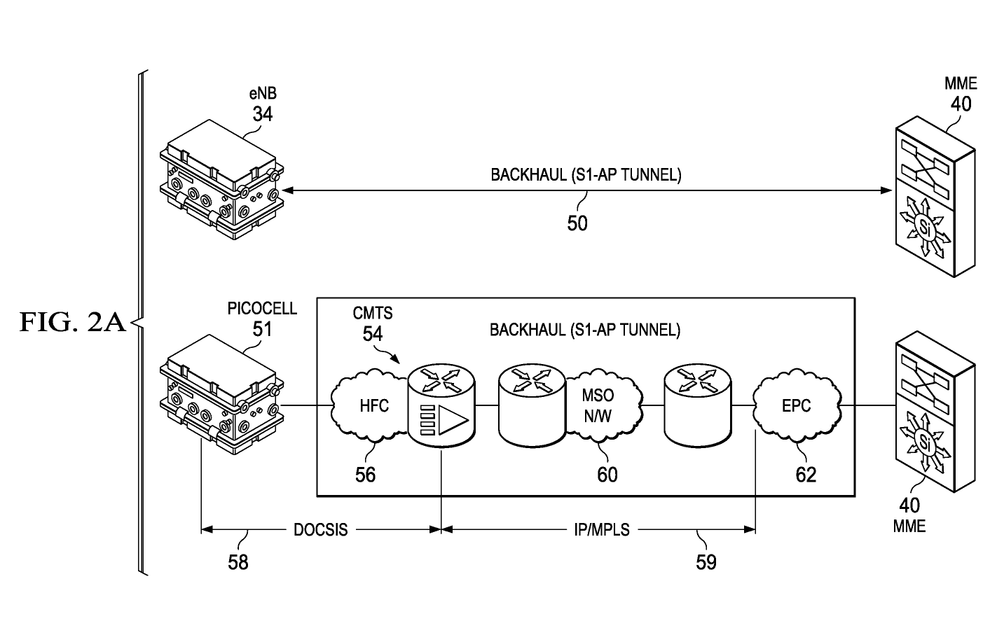

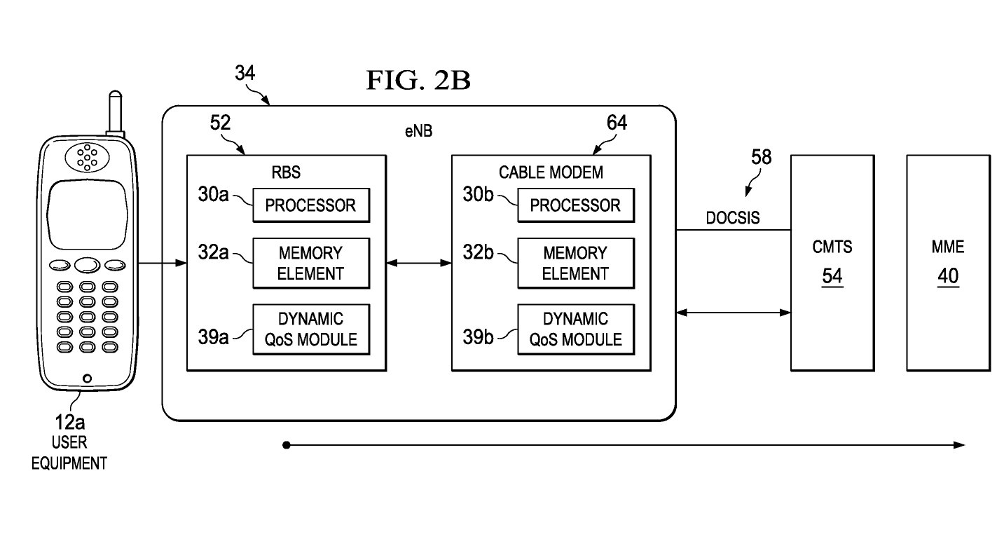

Turning to FIG. 2A, FIG. 2A is an exploded view of a backhaul 50 between eNodeB 34 and MME 40 in one example embodiment of communication system 10. In the embodiment of FIG. 2A, eNodeB 34 is implemented with a picocell 51, which may be connected to a CMTS 54 through an HFC infrastructure 56 using a DOCSIS link 58. Picocell 51 may represent any cellular base station, which may connect to a base station controller, or alternatively, may provide services as an access point base station and bypass a base station controller. Multiple System Operator (MSO) network 60 can connect CMTS 54 to an EPC 62 over an IP/Multiprotocol Label Switching (MPLS) link 59, and EPC 62 can connect CMTS 54 to MME 40.

FIG. 2B is a simplified block diagram illustrating additional details that may be associated with one potential embodiment of communication system 10. FIG. 2B includes eNodeB 34, CMTS 54, and MME 40. eNodeB 34 may include a radio base station (RBS) 52 and a cable modem 64. RBS 52 and cable modem 64 each includes a respective processor 30a-b, a respective memory element 32a-b, and a respective dynamic QoS module 39a-b. Hence, appropriate software and/or hardware can be provisioned in RBS 52 and/or cable modem 64 to facilitate the activities discussed herein.

In one example implementation, eNodeB 34 (including RBS 52 and cable modem 64), CMTS 54, and MME 40 are network elements, which are meant to encompass network appliances, servers, routers, switches, gateways, bridges, loadbalancers, firewalls, base stations, access points, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In regards to the internal structure associated with communication system 10, each of RBS 52 and cable modem 64 can include memory elements (as shown in FIG. 2B) for storing information to be used in achieving the quality of service management operations, as outlined herein. Additionally, each of these devices may include a processor that can execute software or an algorithm to perform the activities discussed herein. These devices may further keep information in any suitable memory element (e.g., random access memory (RAM), read only memory (ROM), an erasable programmable read only memory (EPROM), application specific integrated circuit (ASIC), etc.), software, hardware, or in any other suitable component, device, element, or object where appropriate and based on particular needs. Any of the memory items discussed herein should be construed as being encompassed within the broad term ‘memory element.’ The information being tracked or sent by eNodeB 34 (including RBS 52 and cable modem 64), CMTS 54, and/or MME 40 could be provided in any database, queue, register, control list, or storage structure, all of which can be referenced at any suitable timeframe. Any such storage options may be included within the broad term ‘memory element’ as used herein. Similarly, any of the potential processing elements, modules, and machines described herein should be construed as being encompassed within the broad term ‘processor.’ Each of the network elements and user equipment (e.g., mobile nodes) can also include suitable interfaces for receiving, transmitting, and/or otherwise communicating data or information in a network environment.

In one example implementation, eNodeB 34 (including RBS 52 and cable modem 64), CMTS 54, and/or MME 40 may include software to achieve, or to foster, operations outlined herein. In other embodiments, these operations may be provided externally to these elements, or included in some other network device to achieve this intended functionality. Alternatively, these elements include software (or reciprocating software) that can coordinate in order to achieve the operations, as outlined herein. In still other embodiments, one or all of these devices may include any suitable algorithms, hardware, software, components, modules, interfaces, or objects that facilitate the operations thereof.

Note that in certain example implementations, functions outlined herein may be implemented by logic encoded in one or more tangible media (e.g., embedded logic provided in an ASIC, in DSP instructions, software (potentially inclusive of object code and source code) to be executed by a processor, or other similar machine, etc.). In some of these instances, memory elements (as shown in FIG. 2B) can store data used for the operations described herein. This includes the memory elements being able to store software, logic, code, or processor instructions that are executed to carry out the activities described herein. A processor can execute any type of instructions associated with the data to achieve the operations detailed herein. In one example, the processors (as shown in FIG. 2B) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a digital signal processor (DSP), an EPROM, EEPROM) or an ASIC that includes digital logic, software, code, electronic instructions, or any suitable combination thereof.

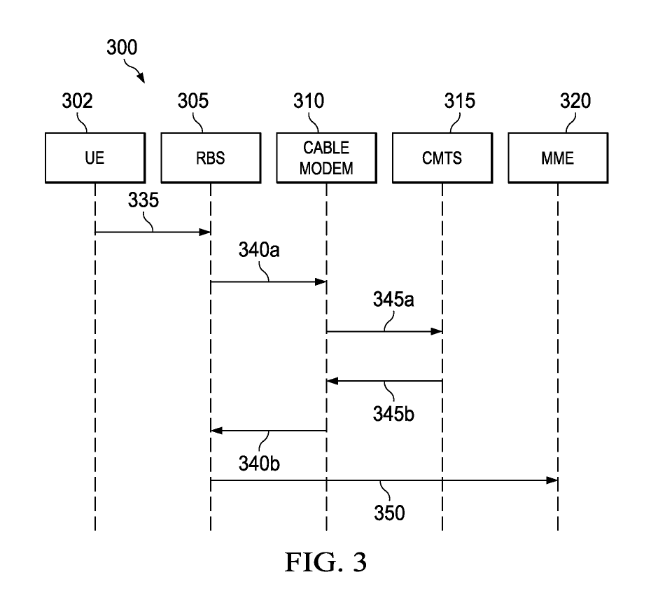

Turning to FIG. 3, FIG. 3 is a simplified flow diagram illustrating service flow creation in a clear tunnel use case 300 for an example embodiment of communication system 10. In this example embodiment, communication system 10 includes UE 302, an RBS 305, a cable modem 310, a CMTS 315, and an MME 320.

In the clear tunnel use case, S1-AP tunnel packets may be sent without an end-to-end encryption, and no IPsec or Layer 2 (L2) virtual private network (VPN) between RBS 305 and MME 320. At 335, UE 302 may begin service flow creation by sending a message to RBS 305 to reserve wireless resources for a service flow, which may be characterized by resource requirements (e.g., bandwidth, latency, delay, class of service, etc.) and service flow identification elements (e.g., source address, destination address, protocols, etc.). The message may specify information elements for a requested QoS class corresponding to the resource requirements, such as a certain QCI value in an LTE environment, for example. At 340, RBS 305 (e.g., a DQoS module in RBS 305) may signal cable modem 310 to setup/activate a new DOCSIS service flow corresponding to the new wireless service flow: specifying the resource requirements and identification elements for the flow. [Note that as used herein in this Specification, the term ‘resource requirements’ is inclusive of characteristics associated with bandwidth, latency, delay, class of service, type of service, quality of service, priority, or any other suitable parameter, which may be associated with the allocation of resources.]

Cable modem 310 may create the DOCSIS service flow with CMTS 315 at 345a-b if the DOCSIS link has the capacity to accommodate the requested resources, thus creating a dedicated pipe for the service flow. Alternatively, CMTS 315 may reject the request or offer a modified flow at 345b. Cable modem 310 can notify RBS 305 of the service flow creation status (e.g., success, failure, or modified) at 340b, and RBS 305 can acknowledge end-to-end QoS to MME 320 at 350 accordingly. Once an E2E service flow is established, cable modem 310 and CMTS 315 may do shallow inspection on tunneled packets to extract flow identification elements (e.g., such as the source address and port, destination address and port, and protocol type). Filters can then be applied to match the LTE service flow to the appropriate DOCSIS service flow.

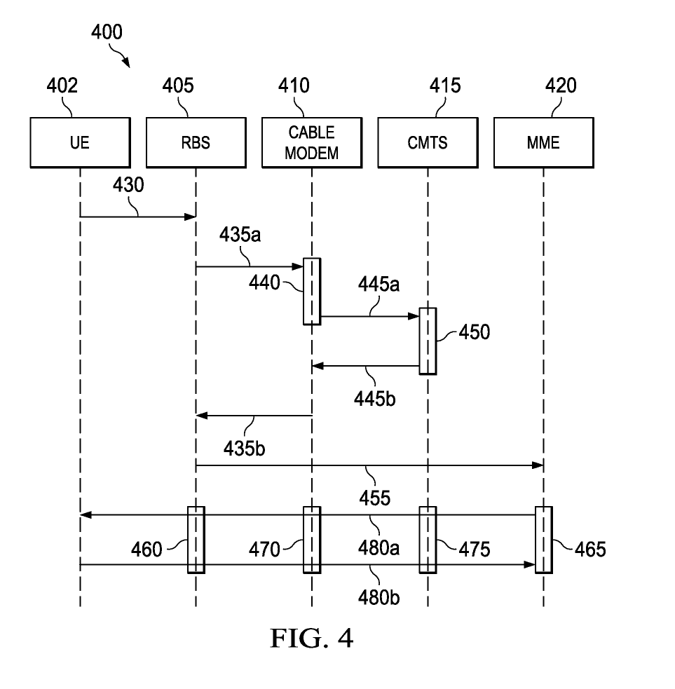

FIG. 4 is a simplified flow diagram illustrating service flow creation and detection in an opaque tunnel use case 400 for an example embodiment of communication system 10. In this example embodiment, communication system 10 includes UE 402, an RBS 405, a cable modem 410, a CMTS 415, and an MME 420. In opaque tunnel use case 400, S1-AP tunnel packets may be encrypted (L2/L3 VPN), and an L2 VPN may be used between RBS 405 and MME 420. RBS 405 and MME 420 may be provisioned to map QoS classes (e.g., QCIs) to specific DSCPs. Cable modem 410 may, a priori, establish a DOCSIS service flow of a certain bandwidth for each QoS class. For example, LTE service flows may be mapped to a single DOCSIS rtPS service flow. Moreover, cable modem 410 and CMTS 415 may be provisioned to map DSCPs into DOCSIS service flows, thus creating a correlation between QoS classes and established DOCSIS service flows.

At 430, UE 402 may begin service flow creation by sending a message to RBS 405 to reserve wireless resources for a service flow, which may be characterized by resource requirements (e.g., bandwidth and delay) and service flow identification elements (e.g., source address, destination address, and protocols). The message may request a QoS class, such as a certain QCI value, for example. At 435a, RBS 405 (e.g., a DQoS module in RBS 405) may signal cable modem 410 to setup/activate a new DOCSIS service flow corresponding to the new wireless service flow, specifying the QoS class.

Cable modem 410 may map wireless service flow to the DOCSIS service flow associated with the QoS class at 440, and request CMTS 415 to modify the DOCSIS service flow parameters (e.g., average and peak rates) at 445a, if such a modification is needed to support the requested QoS. CMTS 415 may modify the DOCSIS service flow at 450, if the DOCSIS link has sufficient capacity to accommodate the request. Alternatively, CMTS 415 may reject the request or offer a modified flow.

CMTS 415 can acknowledge the request and indicate the result of the request at 445b. Cable modem 410 can notify RBS 405 of the service flow creation status (e.g., success, failure, or modified) at 435b, and RBS 405 can acknowledge E2E QoS to MME 420 at 455 accordingly. Assuming an E2E service flow 480a-b is established, RBS 405 and MME 420 can mark packet service types with corresponding DSCP markings at 460 and 465, respectively, and cable modem 410 and CMTS 415 may map the DSCPs to the corresponding DOCSIS service flows at 470 and 475, respectively. For example, LTE QCI 1 service flows may be marked with DSCP expedited forwarding (EF), and EF packets can be mapped to DOCSIS unsolicited grant synchronization (UGS) service flow.

Additionally, an eNodeB may receive an E-RAB modify request from an MME, and can perform call admission control taking into account transport resources. If current resources are reserved, then the eNodeB may request additional transport resources. For example, the eNodeB can record GBR QoS, and decrement its bandwidth from the pool of UGS resources. If the bandwidth pool falls below a predetermined threshold, then the eNodeB may trigger DQoS procedures and reply with a successful E-RAB modify response if more UGS resources are allocated. If additional UGS resources are not allocated, then the eNodeB can respond with an E-RAB modify response indicating that transport resources are unavailable.

While certain embodiments have been described herein in terms of an LTE network, the principles illustrated are applicable generally to any wireless network that has some level of QoS enabled on a wireless link, including WiMAX and HSPA, for example. Thus, the SGW generally represents the first point of un-tunneled IP traffic in a mobile network. In a WiMAX network, for instance, the SGW may be analogous to an Access Service Network Gateway (ASN-GW or AGW). The Agg-PE represents an aggregation node for the mobile backhaul network (e.g., links between the RAN and EPC), and may be terminating a wide range of interface types, such as Ethernet, Synchronous Optical Network (SONET) (OCx), microwave, etc. An eNodeB, as used herein, represents a radio or mobile node that provides the wireless carrier to subscribers. In WiMAX, for instance, an eNodeB may be represented as a base transceiver station (BTS). A cell site element represents any element that provides the routing, switching, and transport functions at the cell site, which may be integrated with or separate from an eNodeB.

Similarly, since communication system 10 may include a configuration capable of TCP/IP communications, existing IP-based mechanisms for signaling and enforcing QoS may also be used throughout the system. Thus, in a WiMAX radio access domain, for example, communication system 10 may use the R6 interface, which allows for signaling of QoS and policy information between an ASN-GW and a BTS. In the transport domain, communication system may use other existing protocols, such as E-LMI and Y.1731 performance management functions, along with pending MEF-20 auto-provisioning functions, for example.

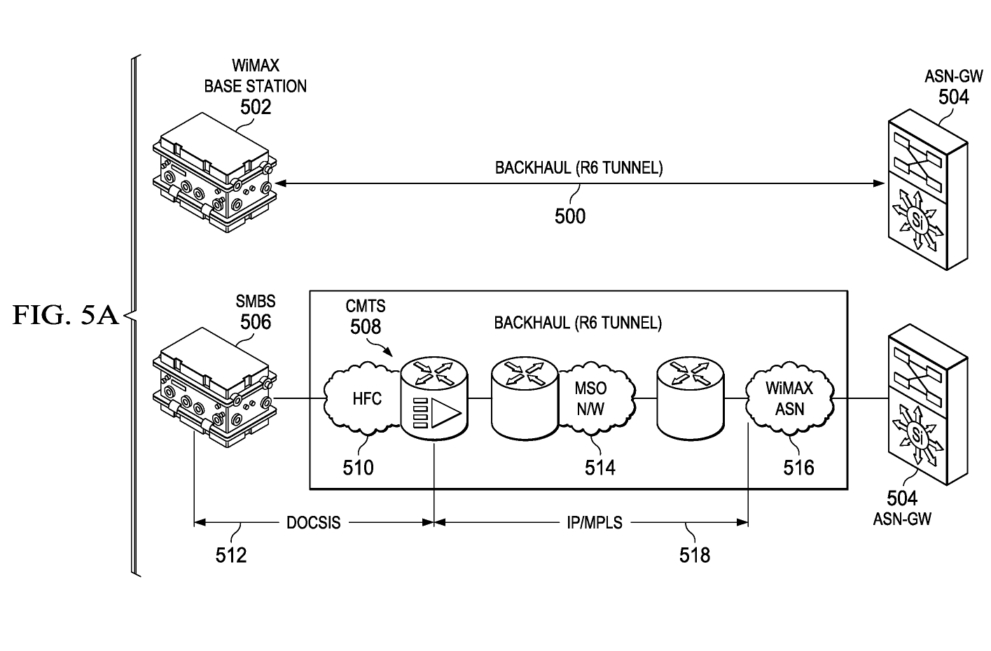

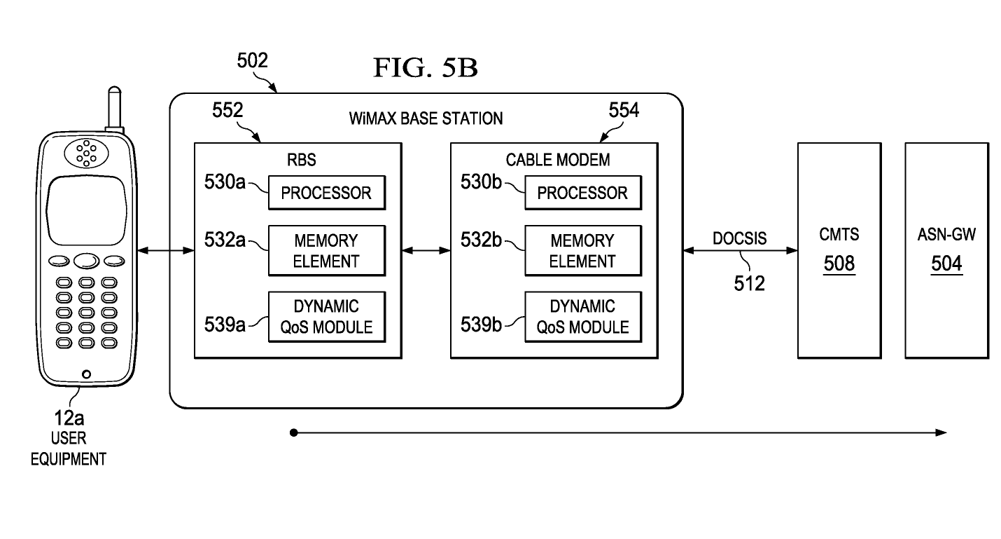

FIG. 5A is a simplified block diagram of an example embodiment of a communication system 10 having a WiMAX network. FIG. 5A includes an exploded view of a backhaul 500 between a WiMAX BTS 502 and an ASN-GW 504, in which BTS 502 is implemented as a strand-mounted base station (SMBS) 506. SMBS 506 may be connected to a CMTS 508 through an HFC infrastructure 510 using a DOCSIS link 512. MSO network 514 connects CMTS 508 to a WiMAX ASN 516 over an IP/MPLS link 518, which may be connected to ASN-GW 504.

FIG. 5B is a simplified block diagram illustrating additional details that may be associated with one potential embodiment of communication system 10 associated with a WiMAX network. FIG. 5B includes BTS 502, CMTS 508, and ASN-GW 504. BTS 502 may include a RBS 552 and a cable modem 554. RBS 552 and cable modem 554 may each include a respective processor 530a-b, a respective memory element 532a-b, and a respective dynamic QoS module 539a-b. Hence, appropriate software and/or hardware may be provisioned in RBS 552 and cable modem 554 to facilitate the activities discussed herein. Also depicted in FIG. 5B is UE 560, which can attach to BTS 502 in order to conduct a communication session.

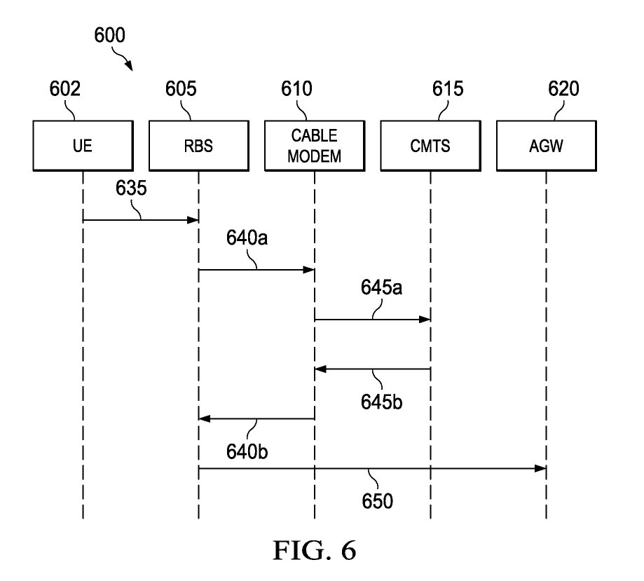

Turning to FIG. 6, FIG. 6 is a simplified flow diagram illustrating service flow creation in a clear tunnel use case 600 for an example embodiment of communication system 10 associated with a WiMAX network. In this example embodiment, communication system 10 includes UE 602, an RBS 605, a cable modem 610, a CMTS 615, and an AGW 620.

In the clear tunnel use case, R6 tunnel packets may be sent without any end-to-end encryption, and no IPsec or Layer 2 (L2) virtual private network (VPN) between RBS 605 and AGW 620. At 635, UE 602 may begin service flow creation by sending a message to RBS 605 to reserve wireless resources for a service flow, which may be characterized by resource requirements (e.g., bandwidth and delay) and service flow identification elements (e.g., source address, destination address, and protocols). The message may specify information elements for a requested QoS class corresponding to the resource requirements, such as for extended rtPS (ertPS), for example. At 640a, RBS 605 (e.g., a DQoS module in RBS 605) may signal cable modem 610 to setup/activate a new DOCSIS service flow corresponding to the new wireless service flow (specifying the resource requirements and identification elements for the flow). Cable modem 610 may create the DOCSIS service flow with CMTS 615 at 645a-b if the DOCSIS link has the capacity to accommodate the requested resources, thus creating a dedicated pipe for the service flow. Alternatively, CMTS 615 may reject the request or offer a modified flow at 645b.

Cable modem 610 may notify RBS 605 of the service flow creation status (e.g., success, failure, or modified) at 640b, and RBS 605 can acknowledge end-to-end QoS to AGW 620 at 650 accordingly. Once an E2E service flow is established, cable modem 610 and CMTS 615 may do shallow inspection on tunneled packets to extract flow identification elements, such as the source address and port, destination address and port, and protocol type, and then apply filters to match the WiMAX service flow to the appropriate DOCSIS service flow.

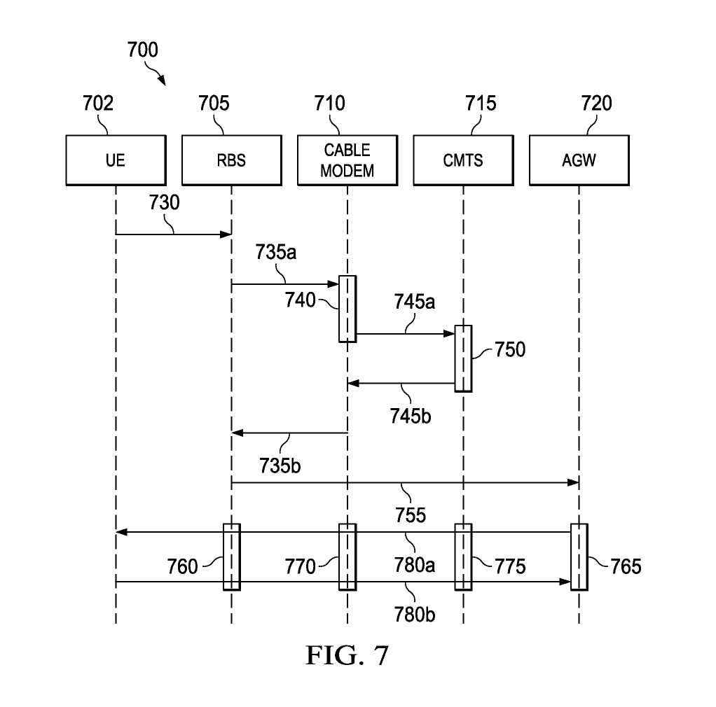

FIG. 7 is a simplified flow diagram illustrating a service flow creation and detection in an opaque tunnel use case 700. This particular example embodiment of communication system 10 can be associated with a WiMAX network. In this example embodiment, communication system 10 includes UE 702, an RBS 705, a cable modem 710, a CMTS 715, and an AGW 720. In the opaque tunnel use case, R6 tunnel packets may be encrypted (L2/L3 VPN), and an L2 VPN may be used between RBS 705 and AGW 720. RBS 705 and AGW 720 may be provisioned to map QoS classes (e.g., rtPS or best effort) to specific DSCPs. Cable modem 710 may, a priori, establish a DOCSIS service flow of a certain bandwidth for each QoS class. For example, WiMAX service flows may be mapped to a single DOCSIS rtPS service flow. Moreover, cable modem 710 and CMTS 715 may be provisioned to map DSCPs into DOCSIS service flows, thus creating a correlation between QoS classes and established DOCSIS service flows.

At 730, UE 702 may begin service flow creation by sending a message to RBS 705 to reserve wireless resources for a service flow, which may be characterized by resource requirements (e.g., bandwidth and delay) and service flow identification elements (e.g., source address, destination address, and protocols). The message may request a QoS class, such as rtPS or best effort, for example. At 735a, RBS 705 (e.g., a DQoS module in RBS 705) may signal cable modem 710 to setup/activate a new DOCSIS service flow corresponding to the new wireless service flow, specifying the QoS class.

Cable modem 710 may map wireless service flow to the DOCSIS service flow associated with the QoS class at 740, and request CMTS 715 to modify the DOCSIS service flow parameters (e.g., average and peak rates) at 745a, if such a modification is needed to support the requested QoS. CMTS 715 may modify the DOCSIS service flow at 750, if the DOCSIS link has sufficient capacity to accommodate the request. Alternatively, CMTS 715 may reject the request or offer a modified flow. CMTS 715 can acknowledge the request and indicate the result of the request at 745b.

Cable modem 710 can notify RBS 705 of the service flow creation status (e.g., success, failure, or modified) at 735b, and RBS 705 can acknowledge E2E QoS to AGW 720 at 755 accordingly. Assuming an E2E service flow 780a-b is established, RBS 705 and AGW 720 can mark packet service types with corresponding DSCP markings at 760 and 765, respectively, and cable modem 710 and CMTS 715 may map the DSCPs to the corresponding DOCSIS service flows at 770 and 775, respectively. For example, WiMAX UGS service flows may be marked with an EF DSCP, and EF packets can be mapped to DOCSIS UGS service flow.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures. Additionally, although described with reference to particular scenarios, where a module (e.g., a dynamic QoS module) is provided within the network elements, these elements can be provided externally, or consolidated and/or combined in any suitable fashion. In certain instances, certain elements may be provided in a single proprietary module, device, unit, etc.

It is also important to note that the steps in the appended diagrams illustrate only some of the possible signaling scenarios and patterns that may be executed by, or within, communication system 10. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a request for a service flow over a wireless link, wherein the request specifies resource requirements;
dynamically reserving bandwidth for the resource requirements in a backhaul link; and
mapping a packet received over the wireless link to the backhaul link based on an identification element associated with the packet and the service flow.

2. The method of claim 1, wherein the request includes a quality of service parameter corresponding to the resource requirements.

3. The method of claim 1, wherein the backhaul link is a Data over Cable Service Interface Specification (DOCSIS) link between a cable modem and a cable modem termination system.

4. The method of claim 1, wherein dynamically reserving bandwidth comprises creating a dedicated DOCSIS link over a hybrid fiber-coaxial backhaul for the service flow.

5. The method of claim 1, wherein the backhaul link is associated with a quality of service class and dynamically reserving bandwidth comprises mapping the resource requirements to the quality of service class.

6. The method of claim 1, wherein the backhaul link is associated with a quality of service class having a predetermined bandwidth, and wherein dynamically reserving bandwidth comprises modifying the predetermined bandwidth to accommodate the resource requirements.

7. The method of claim 1, wherein mapping a packet comprises shallow inspection on the packet to extract the identification element and to apply a filter to match the wireless link to the backhaul link based on the identification element.

8. The method of claim 1, wherein the request includes a quality of service parameter corresponding to the resource requirements, and wherein mapping a packet comprises mapping the quality of service parameter to a differentiated service code point and mapping the differentiated service code point to a DOCSIS service flow type.

9. The method of claim 1, wherein the request includes a quality of service class identifier corresponding to the resource requirements.

10. Logic encoded in non-transitory media that includes code for execution and when executed by a processor operable to perform operations comprising:
receiving a request for a service flow over a wireless link, wherein the request specifies resource requirements;
dynamically reserving bandwidth for the resource requirements in a backhaul link; and
mapping a packet received over the wireless link to the backhaul link based on an identification element associated with the packet and the service flow.

11. The logic of claim 10, wherein the request includes a quality of service parameter corresponding to the resource requirements.

12. The logic of claim 10, wherein the backhaul link is a Data over Cable Service Interface Specification (DOCSIS) link between a cable modem and a cable modem termination system.

13. The logic of claim 10, wherein dynamically reserving bandwidth comprises creating a dedicated DOCSIS link over a hybrid fiber-coaxial backhaul for the service flow.

14. The logic of claim 10, wherein the backhaul link is associated with a quality of service class and dynamically reserving bandwidth comprises mapping the resource requirements to the quality of service class.

15. The logic of claim 10, wherein mapping a packet comprises shallow inspection on the packet to extract the identification element and to apply a filter to match the wireless link to the backhaul link based on the identification element.

16. An apparatus, comprising:
a memory element configured to store electronic code;
a processor operable to execute instructions associated with the electronic code; and
a quality of service module configured to interface with the processor such that the apparatus is configured for:
receiving a request for a service flow over a wireless link, wherein the request specifies resource requirements;
dynamically reserving bandwidth for the resource requirements in a backhaul link; and
mapping a packet received over the wireless link to the backhaul link based on an identification element associated with the packet and the service flow.

17. The apparatus of claim 16, wherein the request includes a quality of service parameter corresponding to the resource requirements.

18. The apparatus of claim 16, wherein the backhaul link is a Data over Cable Service Interface Specification (DOCSIS) link between a cable modem and a cable modem termination system.

19. The apparatus of claim 16, wherein dynamically reserving bandwidth comprises creating a dedicated DOCSIS link over a hybrid fiber-coaxial backhaul for the service flow.

20. The apparatus of claim 16, wherein mapping a packet comprises shallow inspection on the packet to extract the identification element and to apply a filter to match the wireless link to the backhaul link based on the identification element.

21. The apparatus of claim 16, wherein the request includes a quality of service parameter corresponding to the resource requirements, and wherein mapping a packet comprises mapping the quality of service parameter to a differentiated service code point and mapping the differentiated service code point to a DOCSIS service flow type.
